(19) United States
(12) Patent Application Publication
(10) Pub. No.: US 2012/0174715 A1
(43) Pub. Date: Jul. 12, 2012

(54) WRENCH OF RATCHET WHEEL

(76) Inventor: Mingliang Xin, NingBo (CN)

(21) Appl. No.: 13/012,744

(22) Filed: Jan. 24, 2011

(30) Foreign Application Priority Data
Jan. 12, 2011 (CN) 201110005777.3

(51) Int. Cl. B25B 15/04; B25B 23/00

(52) U.S. Cl. 81/59.1; 81/58

(57) ABSTRACT

A wrench of ratchet wheel, to which a high torque force can be applied and which can be widely used, includes a grip, a ratchet wheel mechanism and a driver which successively connect one to another from above to below. The ratchet wheel mechanism includes stem, tumbler member, a first tooth, a second tooth and a tooth pin, wherein the first tooth and the second tooth are flexibly mounted on the stem, the stem is embedded in the tumbler member, the teeth on tooth pin are arranged around the external margin of tooth pin, and the tooth pin and the stem are nest-connected so as to rotate in relative to each other. The ratchet wheel mechanism further includes the third tooth and the fourth tooth, wherein the third tooth and the fourth tooth are flexibly mounted on the stem, and the first tooth, the second tooth, the third tooth and the fourth tooth are successively disposed in the circumference direction of the tooth pin. The tumbler member is provided with a disengaging device which is used to disengage both the first tooth and the third tooth from the teeth on the tooth pin or to disengage both the second tooth and the fourth tooth from the teeth on the tooth pin.

### CROSS REFERENCE TO RELATED APPLICATION

This patent application claims priority to Chinese Patent Application No. 201110005777.3, filed on Jan. 12, 2011, which is hereby incorporated by reference in its entirety.

### TECHNICAL FIELD

The present invention relates to a tool which may be used for fixation or removal of devices, and particularly to a wrench of ratchet wheel.

### BACKGROUND

At present, a ratchet wheel wrench has a ratchet mechanism which includes a stem, a tumbler member, a first tooth, a second tooth and a tooth pin. The first tooth and the second tooth are flexibly mounted on the stem. The stem is embedded into the tumbler member. The tooth pin is embed-connected into the stem are so as to rotate in relative to each other. A block is arranged in the tumbler member to control engagement between one of the first and second teeth and the tooth pin. When rotating the ratchet wheel wrench, the first tooth or the second tooth which is engaged with the tooth pin can stop the tooth pin in one direction. When rotating the ratchet wheel wrench in opposite direction, the tooth can release the tooth pin such that it can be pushed away and retracted into the stem. With the aid of flexibility, the first tooth or the second tooth which is pushed away by the tooth pin can engage with the tooth pin again. Collision occurs at the moment of the engagement, and thus above structure may generate the sound of tick when the ratchet wheel wrench rotates freely. By above ratchet mechanism, torque force applied to the stem can be transmitted to the tooth pin in one direction, and then be transmitted to driver via the tooth pin. The tooth pin falls into two types, wherein the tooth of the tooth pin is positioned around internal margin, namely internal tooth, and the tooth of the tooth pin is positioned around external margin, namely external tooth. Obviously, from above structure, the function of ratchet mechanism is in that, when one of the first and second teeth is engaged with the tooth pin, the stem can be rotated in one direction without pushing the tooth pin, and rotated in opposite direction with pushing the tooth pin and transmitting torque force. Since only one tooth is engaged with the tooth pin (in another word, when the stem pushes the tooth pin to transmit torque force, only one tooth presses against the tooth pin to rotate the tooth pin with the stem), the transmitted torque force is too small (generally less than 18 N) to screw an attachment having high torque force. That is to say, the ratchet wheel wrench in the related art has a small applied torque force, and thus is narrowly used.

### SUMMARY OF THE INVENTION

The object of the present invention is to provide a wrench of ratchet wheel, to which a high torque force can be applied and which can be widely used.

According to the present invention, the wrench of ratchet wheel includes a grip, a ratchet wheel mechanism and a driver which successively connect one to another from above to below. The ratchet wheel mechanism includes stem, tumbler member, a first tooth, a second tooth and a tooth pin, wherein the first tooth and the second tooth are flexibly mounted on the stem, the stem is embedded in the tumbler member, the teeth on tooth pin are arranged around the external margin of tooth pin, and the tooth pin and the stem are nest-connected so as to rotate in relative to each other. The ratchet wheel mechanism further includes a third tooth and a fourth tooth, wherein the third tooth and the fourth tooth are flexibly mounted on the stem, and the first tooth, the second tooth, the third tooth and the fourth tooth are successively disposed in the circumference direction of the tooth pin. The tumbler member is provided with a disengaging device which is used to disengage both the first tooth and the third tooth from the teeth on the tooth pin or to disengage both the second tooth and the fourth tooth from the teeth on the tooth pin.

With such above structure, compared with the existing arts, the present invention has following advantages. The ratchet wheel mechanism further includes a third tooth and a fourth tooth, wherein the third tooth and the fourth tooth are flexibly mounted on the stem, and the first tooth, the second tooth, the third tooth and the fourth tooth are successively disposed in the circumference direction of the tooth pin; the tumbler member is provided with a disengaging device which is used to disengage both the first tooth and the third tooth from the teeth on the tooth pin or to disengage both the second tooth and the fourth tooth from the teeth on the tooth pin. Therefore, when the ratchet wheel wrench is operated, it is ensured that two teeth are engaged with the teeth on tooth pin, i.e., the first tooth and the third tooth are engaged with the teeth on tooth pin or the second tooth and the fourth tooth are engaged with the teeth on tooth pin. Accordingly, a higher torque force, for example 30 N, can be transmitted. Therefore, the ratchet wheel wrench according to the present invention has advantages that a high torque force can be applied to it and it can be widely used.

As a modification, the first tooth and the third tooth are symmetrically disposed in relative to the axis of the tooth pin, and the second tooth and the fourth tooth are symmetrically disposed in relative to the axis of the tooth pin. As known from mechanics common knowledge, the above disposed structure can apply a uniform force to the first tooth and the third tooth or apply a uniform force to the second tooth and the fourth tooth, which facilitates the improvement of the performance of the invention.

As a further modification, the disengaging device includes a first block and a second block which are synchronistically rotatable about the axis of the tooth pin, wherein both the first block and the second block are fixed to the inner circumference of the tumbler member, the first block is located between the first tooth and the second tooth so as to push away the first tooth or the second tooth when the first block rotates, and the second block is located between the third tooth and the fourth tooth so as to push away the third tooth or the fourth tooth when the second block rotates. Therefore, the structure in which a first block and a second block are arranged is not only simple and compact, but also has a reliable performance. It can be ensured that both the first tooth and the third tooth are reliably disengaged from the teeth on tooth pin, or both the second tooth and the fourth tooth are reliably disengaged from the teeth on tooth pin.

As a further modification, the ratchet wheel mechanism further includes a spring, wherein the spring is arranged around the tooth pin, the spring, at one end thereof, is pressed against the first tooth, the second tooth, the third tooth and the fourth tooth at their lower ends, and the spring, at the other end thereof, is pressed against the tooth pin at its internal end side. Therefore, flexibility in the axial direction of the tooth pin is provided between the tooth pin and the first tooth, the second tooth, the third tooth and the fourth tooth. Firstly, flexibility can prevent the first tooth, the second tooth, the third tooth and the fourth tooth from moving in the axial direction of the tooth pin. Secondly, since the first tooth, the second tooth, the third tooth and the fourth tooth at their upper ends are pressed against the stem, flexibility can provide cushion in the axial direction of the tooth pin and the stem so as to prevent the tooth pin and the stem from colliding. Therefore, flexibility can be applied to both the tooth pin and the stem. When the driver is pressed against an attachment (for example a bolt), a cushion occurs in the axial direction of the tooth pin and the stem. The cushion clearance is adjustable, and for example, it can be adjusted to 1 mm. Above modification facilitates a further improvement of the performance of the invention.

As a further modification, the ratchet wheel mechanism further includes a washer, wherein the washer is arranged around the tooth pin and is positioned between the spring and the lower ends of the first tooth, the second tooth, the third tooth and the fourth tooth. Therefore, this can prevent spring and the lower ends of the first tooth, the second tooth, the third tooth and the fourth tooth from wearing with each other, and can apply an even force between spring and the lower ends of the first tooth, the second tooth, the third tooth and the fourth tooth, which facilitates a further improvement of the performance of the invention.

As a further modification, at internal circumference of the tumbler member, a ball positioned notch is provided, wherein a ball, which is mounted in the radial hole of the external circumference of the stem, flexibly contacts with the ball positioned notch. Therefore, as the tumbler member rotates, the ball is pressed against the front or middle or rear rabbet of the ball positioned notch. The function of fitting the ball to the ball positioned notch is to mark an angle by which the tumbler member passes. In fact, this indicates that the first tooth and the third tooth are engaged with the teeth on tooth pin or the second tooth and the fourth tooth are engaged with the teeth on tooth pin, so as to provide a freely rotating direction of the ratchet wheel wrench for the user.

### BRIEF DESCRIPTION OF THE DRAWING FIGURES

FIG. 1 is a cross-sectional view of the ratchet wheel wrench according to the present invention;

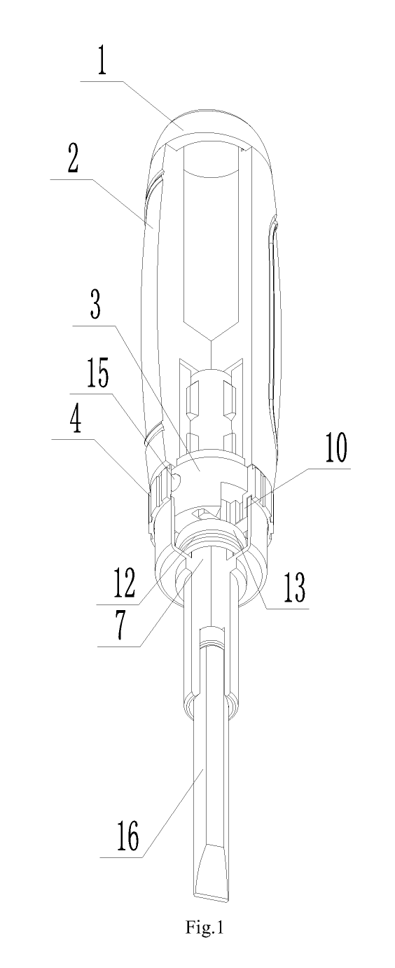

FIG. 2 is an exploded view of the ratchet wheel wrench according to the present invention; and

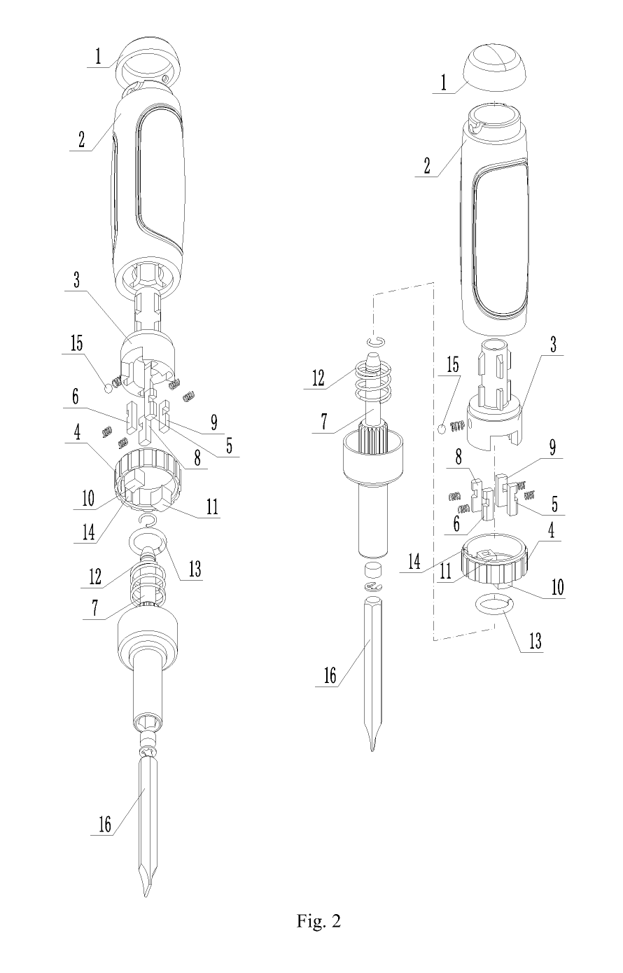

FIG. 3 is another exploded view of the ratchet wheel wrench according to the present invention.

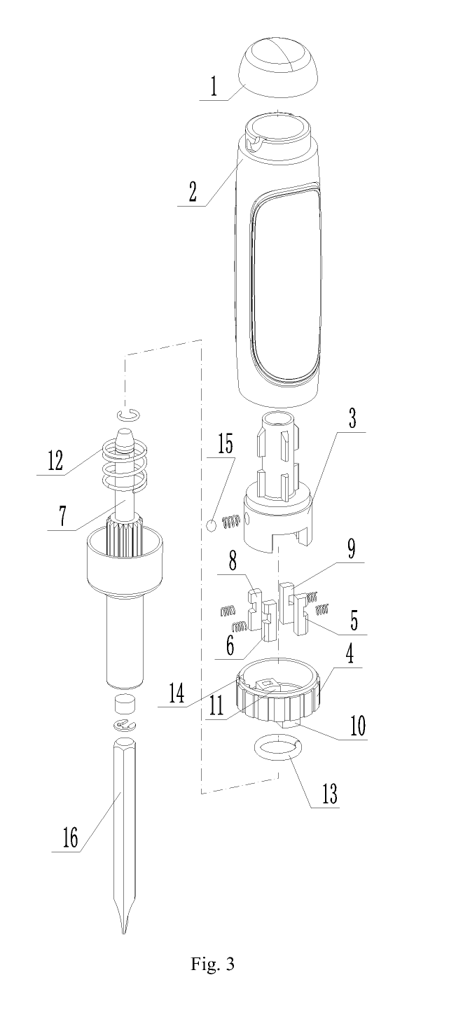

In the figures, reference numeral 1 indicates a cap, 2 indicates a grip, 3 indicates stem, 4 indicates a tumbler member, 5 indicates a first tooth, 6 indicates a second tooth, 7 indicates tooth pin, 8 indicates a third tooth, 9 indicates a fourth tooth, 10 indicates a first block, 11 indicates a second block, 12 indicates a spring, 13 indicates a washer, 14 indicates a ball positioned notch, 15 indicates a ball, and 16 indicates a driver.

### DETAILED DESCRIPTION OF THE PREFERRED EMBODIMENT

The details of the present invention are set forth in the accompanying drawings below.

The wrench of ratchet wheel according to the present invention includes a grip 2, a ratchet wheel mechanism and a driver 16 which successively connect one to another from above to below. The ratchet wheel mechanism includes stem 3, tumbler member 4, a first tooth 5, a second tooth 6 and a tooth pin 7, wherein the first tooth 5 and the second tooth 6 are flexibly mounted on the stem 3, the stem 3 is embedded in the tumbler member 4, the teeth on tooth pin 7 are arranged around the external margin of tooth pin 7, and the tooth pin 7 and the stem 3 are nest-connected so as to rotate in relative to each other. The ratchet wheel mechanism further includes a third tooth 8 and a fourth tooth 9, wherein the third tooth 8 and the fourth tooth 9 are flexibly mounted on the stem 3. The first tooth 5, the second tooth 6, the third tooth 8 and the fourth tooth 9 are successively disposed in the circumference direction of the tooth pin 7. The tumbler member 4 is provided with a disengaging device which is used to disengage both the first tooth 5 and the third tooth 8 from the teeth on the tooth pin 7 or to disengage both the second tooth 6 and the fourth tooth 9 from the teeth on the tooth pin 7.

The first tooth 5 and the third tooth 8 are symmetrically disposed in relative to the axis of the tooth pin 7, and the second tooth 6 and the fourth tooth 9 are symmetrically disposed in relative to the axis of the tooth pin 7.

The disengaging device includes a first block 10 and a second block 11 which are synchronistically rotatable about the axis of the tooth pin 7. Both the first block 10 and the second block 11 are fixed to the inner circumference of the tumbler member 4. The first block 10 is located between the first tooth 5 and the second tooth 6 so as to push away the first tooth 5 or the second tooth 6 when the first block 10 rotates. The second block 11 is located between the third tooth 8 and the fourth tooth 9 so as to push away the third tooth 8 or the fourth tooth 9 when the second block 11 rotates. In this embodiment, the first block 10 and the second block 11 and the tumbler member 4 are formed as a single piece by injection molding.

The ratchet wheel mechanism further includes a spring 12. The spring 12 is arranged around the tooth pin 7. The spring 12, at one end thereof, is pressed against the first tooth 5, the second tooth 6, the third tooth 8 and the fourth tooth 9 at their lower ends; the spring 12, at the other end thereof, is pressed against the tooth pin 7 at its internal end side.

The ratchet wheel mechanism further includes a washer 13. The washer 13 is arranged around the tooth pin 7 and is positioned between the spring 12 and the lower ends of the first tooth 5, the second tooth 6, the third tooth 8 and the fourth tooth 9. That is to say, the washer 13, at the lower side thereof, is pressed against an end of the spring 12; the washer 13, at the upper side thereof, is pressed against the lower ends of the first tooth 5, the second tooth 6, the third tooth 8 and the fourth tooth 9.

At internal circumference of the tumbler member 4, a ball positioned notch 14 is provided. A ball 15, which is mounted in the radial hole of the external circumference of the stem 3, flexibly contacts with the ball positioned notch 14. Except for such a structure in which the ball positioned notch 14 and the ball 15 are provided, damping may exist between the tumbler member 4 and the stem 3 or the nested-connection between the tumbler member 4 and the stem 3 may become somewhat firmer, as long as the tumbler member 4 and the stem 3 can only rotate in relative to each other under the driving of external force.

The grip 2 has a cap 1 which is used to prevent the driver arranged inside the grip 2 from dropping down.

The successive connection, from above to below, of the grip 2, the ratchet wheel mechanism and the driver 16 means the connection between grip 2 and stem 4, and the connection between the tooth pin 7 and the driver 16. The connection between the grip 2 and the stem 4, and the connection between the tooth pin 7 and the driver 16 can be accomplished by the existing art. For example, the stem 3 is connected to the grip 2 by interpose-fitting the stem 3 in the grip 2; the driver 16 is connected to the tooth pin 7 by a magnet which is mounted on bottom of the center hole at the lower portion of the tooth pin 7. The driver 16 is fixed on bottom of the center hole of the tooth pin 7 by the magnet. The center hole and the driver 16 have a cross-section in a shape of hexagon, so that the center hole can be fitted to the driver 16.

The specific shapes of the first tooth 5, the second tooth 6, the third tooth 8 and the fourth tooth 9 and the flexibly mounting manner can be accomplished by existing arts. For example, shapes of the first tooth 5, the second tooth 6, the third tooth 8 and the fourth tooth 9 are existing shapes. Four notches are set on the inner wall of the stem 3. The first tooth 5, the second tooth 6, the third tooth 8 and the fourth tooth 9 are fitted to the four notches. A compression spring, which is arranges between the first tooth 5, the second tooth 6, the third tooth 8 and the fourth tooth 9 and the notches, provides flexibility. Therefore, it is very convenient that new products can be manufactured by adopting existing equipments. In this embodiment, the first tooth 5, the second tooth 6, the third tooth 8 and the fourth tooth 9 are disposed in a shape of rectangle from the cross-sectional view, and the axis of the tooth pin 7 passes through the rectangle center, i.e., the first tooth 5, the second tooth 6, the third tooth 8 and the fourth tooth 9 are located at the four corners of the rectangle.

We claim:

1. A wrench of ratchet wheel, includes a grip, a ratchet wheel mechanism and a driver which successively connect one to another from above to below, the ratchet wheel mechanism including stem, tumbler member, a first tooth, a second tooth and a tooth pin, wherein the first tooth and the second tooth are flexibly mounted on the stem, the stem is embedded in the tumbler member, the teeth on tooth pin are arranged around the external margin of tooth pin, and the tooth pin and the stem are nest-connected so as to rotate in relative to each other, characterized in that,
the ratchet wheel mechanism further including a third tooth and a fourth tooth, wherein the third tooth and the fourth tooth are flexibly mounted on the stem, and the first tooth, the second tooth, the third tooth and the fourth tooth are successively disposed in the circumference direction of the tooth pin;
the tumbler member being provided with a disengaging device which is used to disengage both the first tooth and the third tooth from the teeth on the tooth pin or to disengage both the second tooth and the fourth tooth from the teeth on the tooth pin.

2. The wrench of ratchet wheel according to claim 1, characterized in that,
the first tooth and the third tooth are symmetrically disposed in relative to the axis of the tooth pin, and the second tooth and the fourth tooth are symmetrically disposed in relative to the axis of the tooth pin.

3. The wrench of ratchet wheel according to claim 1, characterized in that,
the disengaging device includes a first block and a second block which are synchronistically rotatable about the axis of the tooth pin, wherein both the first block and the second block are fixed to the inner circumference of the tumbler member, the first block is located between the first tooth and the second tooth so as to push away the first tooth or the second tooth when the first block rotates, and the second block is located between the third tooth and the fourth tooth so as to push away the third tooth or the fourth tooth when the second block rotates.

4. The wrench of ratchet wheel according to claim 1, characterized in that,
the ratchet wheel mechanism further includes a spring, wherein the spring is arranged around the tooth pin, the spring, at one end thereof, is pressed against the first tooth, the second tooth, the third tooth and the fourth tooth at their lower ends, and the spring, at the other end thereof, is pressed against the tooth pin at its internal end side.

5. The wrench of ratchet wheel according to claim 4, characterized in that,
the ratchet wheel mechanism further includes a washer, wherein the washer is arranged around the tooth pin and is positioned between the spring and the lower ends of the first tooth, the second tooth, the third tooth and the fourth tooth.

6. The wrench of ratchet wheel according to claim 1, characterized in that,
at internal circumference of the tumbler member, a ball positioned notch is provided, wherein a ball, which is mounted in the radial hole of the external circumference of the stem, flexibly contacts with the ball positioned notch.
